(19) United States
(12) Patent Application Publication
(10) Pub. No.: US 2026/0296231 A1
(43) Pub. Date: Oct. 1, 2026

(54) CHARGING APPARATUS FOR A MOBILITY DEVICE, AND A MOBILITY DEVICE HAVING THE SAME

(71) Applicants: HYUNDAI MOTOR COMPANY, Seoul (KR); KIA CORPORATION, Seoul (KR)

(72) Inventor: Ji Hoon Kim, Hwaseong-si (KR)

(73) Assignees: HYUNDAI MOTOR COMPANY, Seoul (KR); KIA CORPORATION, Seoul (KR)

(21) Appl. No.: 19/351,643

(22) Filed: Oct. 7, 2025

(30) Foreign Application Priority Data
Mar. 26, 2025 (KR) 10 2025 0038622

(51) Int. Cl. B60L 53/16; H01R 13/703; H02J 7/00

(52) U.S. Cl. CPC B60L 53/16; H01R 13/7036; H01R 2201/26; H02J 7/70

(57) ABSTRACT

A charging apparatus for a mobility device includes a plurality of charging connectors to which an external charger is connected and which are located at different positions on the mobility device, and a charging unit disposed inside of the mobility device and connected to the plurality of charging connectors, wherein each of the plurality of charging connectors includes a first terminal connected to the charging unit and a second terminal that is electrically separated from the first terminal and configured to contact a connector of the external charger.

### CROSS-REFERENCE TO RELATED APPLICATION

This application claims priority to and the benefit of Korean Patent Application No. 10-2025-0038622 under 35 U.S.C. § 119, filed on Mar. 26, 2025, the disclosure of which is incorporated herein by reference in its entirety.

### FIELD

The present disclosure generally relates to a charging apparatus for a mobility device and a mobility device having the same.

### BACKGROUND

A charging apparatus of a mobility device can be connected to an external charger to charge a charging unit of the mobility device with electricity. The external charger may be provided in a building, residence, or charging station, and a connector to which the external charger is connected by a wire may be connected to a connector provided in a charging port of the mobility device.

Meanwhile, charging ports may be provided at a plurality of locations in the mobility device. For example, charging ports may be provided at the front of the mobility device as well as at the rear of the mobility device. Alternatively, in addition to the charging port that a person directly connects, there is a charging method in which, when the charging port of the mobility device is aligned with the connector of the external charger installed on a floor, as an unmanned charging concept, the connector of the external charger and the connector of the charging port of the mobility device are automatically connected without human intervention.

However, in cases like this, in which the plurality of charging ports are provided, although the convenience of charging is high, there is a very high risk of safety accidents. There is a problem that an electric shock accident may occur because while charging is in progress through the charging port on one side, current is also flowing through the charging port on the other side.

The above information disclosed in this Background section is only for understanding of the background of the disclosure, and, therefore, it may contain information that does not constitute prior art.

### SUMMARY

The present disclosure is directed to a charging apparatus for a mobility device capable of preventing accidents even when a plurality of charging ports connected to an external charger are provided, and a mobility device having the same.

According to an aspect of the present disclosure, a charging apparatus for a mobility device includes: a plurality of charging connectors to which an external charger is connected and which are located at different positions on the mobility device, and a charging unit disposed inside of the mobility device and connected to the plurality of charging connectors. In particular, each of the plurality of charging connectors includes a first terminal connected to the charging unit and a second terminal that is electrically separated from the first terminal and configured to contact a connector of the external charger.

The first terminal may be tucked in by the external charger and come into contact with the second terminal so that the external charger and the charging unit are electrically connected.

The second terminal may be fixed to a housing of the charging connector, and the first terminal may be formed to be elastically deformable.

The first terminal may be located around the second terminal.

The first terminal may include a first electrode connected to the charging unit, a second electrode bent from the first electrode to be away from the first electrode, and a third electrode bent from the second electrode to be close to the first electrode.

In case that the first electrode or the second electrode is deformed by coming into contact with the external charger, the second electrode or the first electrode may be in contact with the second terminal, and the external charger and the charging unit may be electrically connected.

The charging connector may include a front charging connector located at the front of the mobility device and a rear charging connector located at the rear of the mobility device.

The first terminal may be fixed to a housing of the charging connector, and the second terminal may be formed to be slidable on the charging connector.

The second terminal may be connected to the charging connector to be slidable i a vertical direction.

The second terminal may be moved toward the first terminal by the external charger while being lifted upward and may come into contact with the first terminal so that the external charger and the charging unit are electrically connected.

The first terminal and the second terminal may be located on a bottom of the mobility device.

According to another aspect of the present disclosure, a mobility device includes: a charging apparatus connected to an external charger, wherein the charging apparatus includes a plurality of charging connectors to which an external charger is connected and which are located at different positions on the mobility device; and a charging unit disposed inside of the mobility device and connected to the plurality of charging connectors. In particular, each of the plurality of charging connectors includes a first terminal connected to the charging unit and a second terminal that is electrically separated from the first terminal and configured to contact a connector of the external charger.

Some of the plurality of charging connectors may be disposed at a front of the mobility device, and others of the plurality of charging connectors may be disposed at a rear of the mobility device.

Some of the plurality of charging connectors may be disposed at a bottom of the mobility device.

Each of the plurality of charging connectors may include a front charging connector located at a front of the mobility device and a rear charging connector located at a rear of the mobility device.

### BRIEF DESCRIPTION OF THE DRAWINGS

The above and other objects, features and advantages of the present disclosure should become more apparent to those of ordinary skill in the art by describing embodiments thereof in detail with reference to the accompanying drawings, in which:

FIG. 1 is a schematic diagram illustrating a mobility device which performs charging through a charging connector located at the front thereof according to an embodiment;

FIG. 2 is a schematic diagram illustrating the mobility device which performs charging through a charging connector located at the rear thereof according to the embodiment;

FIG. 3 is a schematic diagram illustrating a charging apparatus for a mobility device according to an embodiment;

FIG. 4 is a schematic diagram illustrating a connector of an external charger and a charging connector of the charging apparatus according to the embodiment;

FIG. 5 is a schematic diagram illustrating a state in which the connector of the external charger is inserted into the charging connector;

FIG. 6 is a schematic diagram illustrating a state of a rear charging connector and a state of a front charging connector when charging is performed through the rear charging connector.

FIG. 7 is a schematic drawing illustrating an unmanned external charger and the charging apparatus for a mobility device according to the embodiment;

FIG. 8 is a schematic drawing illustrating a charging apparatus for a mobility device according to another embodiment;

FIG. 9 is a schematic diagram illustrating a connector of an unmanned external charger and a charging connector of the charging apparatus according to the embodiment; and

FIG. 10 is a schematic diagram illustrating a state in which the connector of the unmanned external charger is inserted into the charging connector.

### DETAILED DESCRIPTION

The present disclosure can be modified in various ways and has various embodiments. Specific embodiments are illustrated in the accompanying drawings and are described in detail. However, this is not intended to limit the present disclosure to the specific embodiments, but should be understood to include all transformations, equivalents, or substitutes included in the spirit and technical scope of the present disclosure.

Terms that include ordinal numbers, such as “second,” “first,” or the like, may be used to describe various components, but the components are not limited by the terms. The terms are used solely to distinguish one component from another. For example, without departing from the scope of the present disclosure, a second component could be named a first component, and similarly, a first component could also be named a second component. The term “and/or” includes any combination of multiple related/described items or any one of multiple/related described items.

When a component is “connected” or “linked” to another component, it should be understood that it may be directly connected or linked to the other component, or there may also be other components therebetween. On the other hand, when it is said that a component is “directly connected” or “directly linked” to another component, it should be understood that there are no other components therebetween. When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

The terminology used in this application is only used to describe specific embodiments and is not intended to limit the present disclosure. A singular expression includes the plural expression unless the context clearly indicates otherwise. In this application, it should be understood that terms such as “include” and “have” are intended to specify the presence of a feature, number, step, operation, component, part, or combination thereof described in the specification, but do not exclude in advance the possibility of the presence or addition of one or more other features, numbers, steps, operations, components, parts, or combinations thereof.

Unless otherwise defined, all terms used herein, including technical or scientific terms, have the same meaning as commonly understood by a person of ordinary skill in the art to which this disclosure belongs. Terms defined in commonly used dictionaries should be interpreted as having meanings consistent with their meanings in the context of the relevant art, and will not be interpreted in an idealized or overly formal sense, unless expressly defined otherwise in this application.

Hereinafter, embodiments are described in detail with reference to the attached drawings. Regardless of the drawing numbers, identical or corresponding components are given the same reference numerals, and redundant descriptions thereof are omitted.

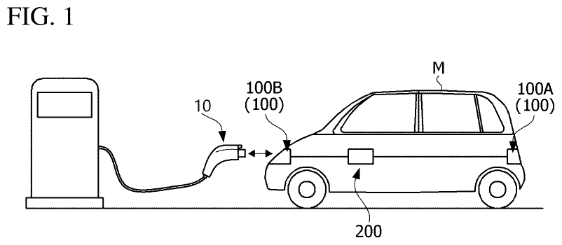

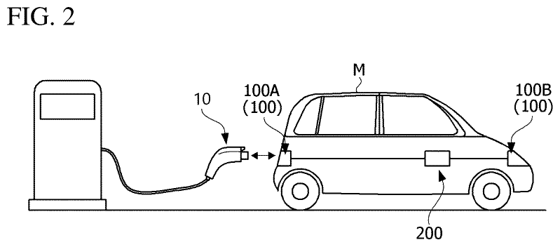

FIG. 1 is a schematic drawing illustrating a mobility device which performs charging through a charging connector 100B located at the front thereof according to an embodiment, and FIG. 2 is a schematic drawing illustrating the mobility device which performs charging through a charging connector 100A located at the rear thereof according to the embodiment.

According to the embodiment, referring to FIG. 1, the mobility device may include a charging connector 100 provided in a plurality of charging ports at different positions. For example, the mobility device M may include a front charging connector 100B located at the front of the mobility device M and a rear charging connector 100A located at the rear of the mobility device M. A connector of an external charger 10 may be connected to the front charging connector 100B located at the front of the mobility device M. This may be determined by a user considering a parking position or shape of the mobility device M and a position of the external charger 10.

Referring to FIG. 2, the connector of the external charger 10 may be connected to the rear charging connector 100A located at the rear of the mobility device M. This may also be determined by the user considering the parking position or shape of the mobility device M and the position of the external charger 10. For example, the location of the front charging connector 100B may be located around opposite to the location of the rear charging connector 100A.

In this way, when the mobility device M is equipped with a plurality of charging connectors 100 at different positions, the convenience of charging can be improved by selecting the plurality of charging connectors 100 in consideration of the external charger 10 and the parking environment.

Each of the charging connectors 100 may be electrically connected to a charging unit 200 of the mobility device M. The charging connector 100 may be a charging connector for low-speed charging that charges at low electric power using a standard household connector. However, the present disclosure is not limited thereto, and the charging connector 100 may be a charging connector for high-speed charging. The charging unit 200 of the mobility device M may include a battery and a device for managing the battery.

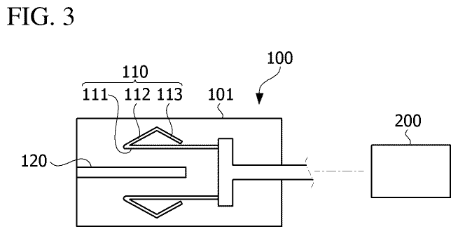

FIG. 3 is a schematic drawing illustrating a charging apparatus for a mobility device according to an embodiment.

Referring to FIG. 3, the charging apparatus for a mobility device according to the embodiment may include the charging connector 100 and the charging unit 200. The charging apparatus for a mobility device includes a plurality of charging ports, and each of the charging ports may be provided with the charging connector 100. The charging connector 100 may include a first terminal 110 and a second terminal 120. Each of the first terminal 110 and the second terminal 120 may be made of a conductive material. Furthermore, the first terminal 110 and the second terminal 120 may be physically separated from each other. The first terminal 110 may be electrically connected to the charging unit 200. The second terminal 120 may not be electrically connected to the charging unit 200 and may be physically separated from the first terminal 110. The second terminal 120 may be fixed to a housing 101 of the charging connector.

The first terminal 110 may be elastically deformed when the external charger 10 is inserted into the charging connector 100 and may come into contact with the second terminal 120, thereby electrically connecting the external charger 10 and the charging unit 200. This first terminal 110 may include a first electrode 111, a second electrode 112, and a third electrode 113.

The first electrode 111 may be electrically connected to the charging unit 200. The first electrode 111 may be implemented in various shapes, such as a cylindrical shape, a polygonal cylindrical shape, or an elliptical cylindrical shape, which is formed with a space therein. Alternatively, the first electrode 111 may be formed of a plurality of separate segments. The second electrode 112 may be formed to be bent outward from the first electrode 111 and to be away from the first electrode 111 at an end of the first electrode 111. The second electrode 112 may be bent from the first electrode 111 to form an acute angle with respect to the first electrode 111. For example, the second electrode 112 may be formed of a plurality of segments that are bent and extended from the first electrode 111. The third electrode 113 may be bent from the second electrode 112 to be close to the first electrode 111 from the second electrode 112. For example, the third electrode 113 may be formed to form an obtuse angle with respect to the second electrode 112. When a corner portion formed by the second electrode 112 and the third electrode 113 is pressed, the first electrode 111 may be elastically deformed and come into contact with the second terminal 120.

The first terminal 110 may be located deeply inside a housing of the charging connector 100 not to be visible from outside the housing of the charging connector 100.

The second terminal 120 may be fixed to the housing 101 of the charging connector. The second terminal 120 may be physically separated from the first terminal 110. A part of the second terminal 120 may be located inside the first electrode 111 of the first terminal 110. The second terminal 120 may be formed as a single segment or multiple segments. The second terminal 120 may be inserted into a terminal 1a of the connector of the external charger 10.

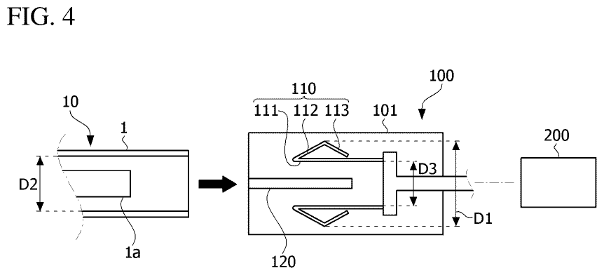

FIG. 4 is a schematic diagram illustrating the connector of the external charger 10 and a charging connector 100 of the charging apparatus according to the embodiment.

Referring to FIG. 4, the connector of the external charger 10 may be inserted into the charging connector 100 of the charging apparatus according to the embodiment. The connector of the external charger 10 may include a housing 1 and a terminal 1a which is disposed inside the housing 1. During a process of coupling the connector of the external charger 10 to the charging connector 100, the terminal 1a of the connector of the external charger 10 may be coupled to the second terminal 120 of the charging connector 100, and an inner wall of the housing 1 of the connector of the external charger 10 may come into contact with the first terminal 110. In other words, the first terminal 110 may be snuggly fit into the housing 1 of the connector of the external charger 10.

During the process of coupling the connector of the external charger 10 to the charging connector 100, in order to induce elastic deformation of the first terminal 110, a maximum width D1 of the first terminal 110 may be be greater than a width D2 of the inner wall of the housing 1 of the connector of the external charger 10. Additionally, a width D3 of the first electrode 111 of the charging connector 100 may be be smaller than the width D2 of the inner wall of the housing 1 of the connector of the external charger 10.

Before the connector of the external charger 10 is coupled to the charging connector 100, the first terminal 110 and the second terminal 120 of the charging connector 100 may be physically separated from each other. Thus, a user (or driver) may not come into contact with the second terminal 120 and an accident such as an electric shock accident may not occur.

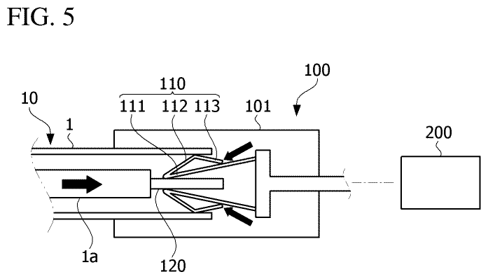

FIG. 5 is a schematic diagram illustrating a state in which the connector of the external charger 10 is inserted into the charging connector 100.

Referring to FIG. 5, when the connector of the external charger 10 is inserted into the charging connector 100, the external charger 10 and the charging unit 200 may electrically connected and charging may proceed. When the connector of the external charger 10 is inserted into the charging connector 100, the terminal 1a of the connector of the external charger 10 may be coupled to the second terminal 120 of the charging connector 100. Additionally, a boundary portion between the second electrode 112 and the third electrode 113 of the charging connector 100 may be elastically deformed toward the second terminal 120 while being pressed against the inner wall of the housing 1 of the connector of the external charger 10.

In this way, as the first terminal 110 is elastically deformed, the first terminal 110 and the second terminal 120 may be electrically connected. Thus, the external charger 10 and the charging unit 200 may be electrically connected, and charging of the mobility device M may proceed.

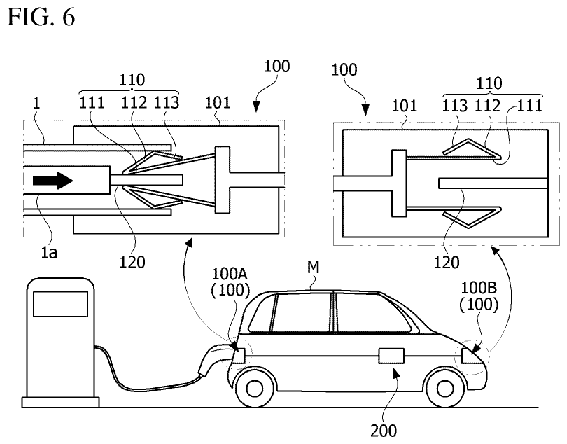

FIG. 6 is a schematic diagram illustrating the state of the rear charging connector 100A and the state of the front charging connector 100B when charging is performed through the rear charging connector 100A.

Referring to FIG. 6, in the case that the mobility device M including the rear charging connector 100A and the front charging connector 100B is charged, and charging may be performed through the rear charging connector 100A, when the first terminal 110 is elastically deformed and comes into contact with the second terminal 120, the external charger 10 and the charging unit 200 may be electrically connected so that charging proceeds. Meanwhile, in the front charging connector 100B, since the first terminal 110 and the second terminal 120 are separated from each other, no current flows to the second terminal 120. Since no current flows from the front charging connector 100B to the second terminal 120, a user's safety may be ensured even when the user's hand touches the second terminal 120 of the front charging connector 100B in a state in which the charging port at the front of the mobility device M is open.

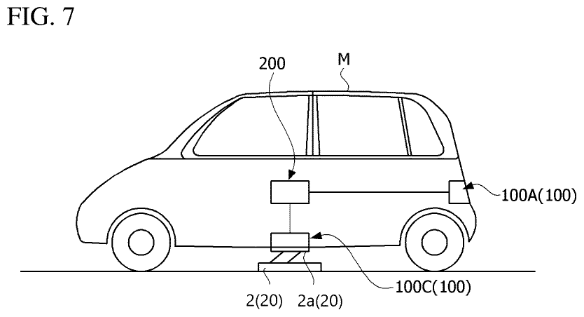

FIG. 7 is a schematic drawing illustrating the unmanned external charger 10 and the charging apparatus for a mobility device according to the embodiment.

Referring to FIG. 7, in response to an unmanned external charger 20 located on the ground, the charging apparatus for a mobility device according to the embodiment may include a lower charging connector 100C. The unmanned external charger 20 may be located on the ground. A connector 2a of the unmanned external charger 20 may be lifted upward from a body 2 of the unmanned external charger 20 and come into contact with the lower charging connector 100C of the mobility device M. When the mobility device M approaches the unmanned external charger 20, and as the unmanned external charger 20 and the lower charging connector 100C of the mobility device M are vertically aligned together, the connector 2a of the unmanned external charger 20 may be lifted upward and electrically connected to the lower charging connector 100C. Thus, the charging unit 200 may be automatically charged through the lower charging connector 100C without connection of a separate cable. For example, lifting the body 2 of the unmanned external charger 20 may be lifted manually or automatically as the mobility device M approaches to the unmanned external charger 20.

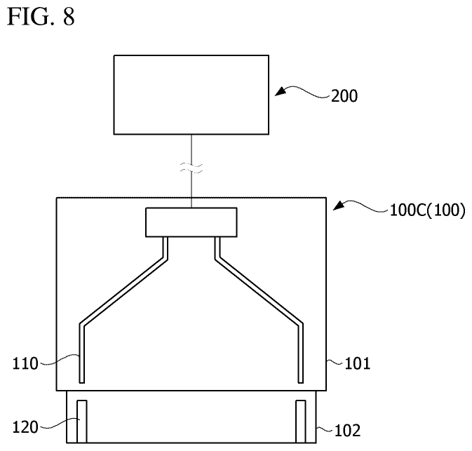

FIG. 8 is a schematic drawing illustrating a charging apparatus for a mobility device according to another embodiment.

Referring to FIG. 8, the charging apparatus for a mobility device according to the embodiment includes the first terminal 110 and the second terminal 120. The first terminal 110 may be electrically connected to the charging unit 200. The first terminal 110 may be fixed to the housing 101 of the charging connector 100. The second terminal 120 may be vertically spaced apart from the first terminal 110. The second terminal 120 may be fixed to a sub-housing 102. The sub-housing 102 may be coupled to the housing 101 of the charging connector 100 to be slidable in a vertical direction. In other words, the sub-housing 102 of the second terminal 120 may be snuggly fit into the housing 101 of the charging connector 100. The first terminal 110 and the second terminal 120 may be aligned vertically.

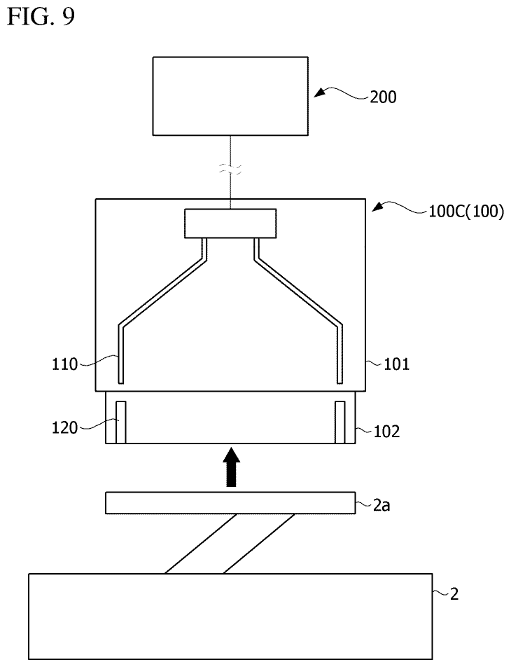

FIG. 9 is a schematic diagram illustrating the connector 2a of the unmanned external charger 20 and the charging connector 100 of the charging apparatus according to the embodiment.

Referring to FIG. 9, the connector 2a of the unmanned external charger 20 may be in contact with the lower charging connector 100C of the charging apparatus according to the embodiment. The connector 2a of the unmanned external charger 20 may include the body 2 and the connector 2a lifted upward from the body 2. The connector 2a of the unmanned external charger 20 may be lifted toward the lower charging connector 100C when the mobility device M is brought underneath of the unmanned external charger 20 and vertically aligned with the lower charging connector 100C. The sub-housing 102 of the lower charging connector 100C may be formed to correspond to a shape of the connector 2a of the unmanned external charger 20. A size and shape of the first terminal 110 and a size and shape of the second terminal 120 may be formed to correspond to the shape of the connector 2a of the unmanned external charger 20. The second terminal 120 may be formed in a cylindrical shape, an elliptical shape, or a combination of multiple sections.

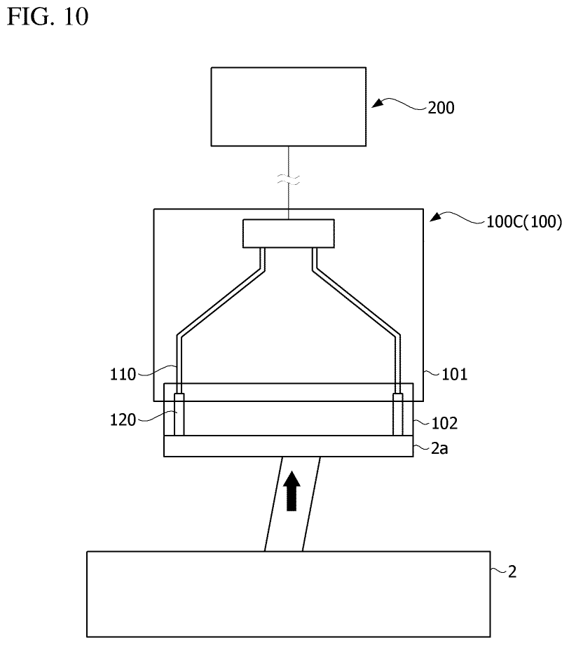

FIG. 10 is a schematic diagram illustrating a state in which the connector 2a of the unmanned external charger 20 is inserted into the charging connector 100.

Referring to FIG. 10, the connector 2a of the unmanned external charger 20 may be lifted upward and come into contact with the second terminal 120 of the lower charging connector 100C. When the lifting operation continues in a state in which the connector 2a of the unmanned external charger 20 is in contact with the second terminal 120, the sub-housing 102 may slide and move upward due to the connector 2a of the unmanned external charger 20. As the sub-housing 102 moves upward, the second terminal 120 may come into contact with the first terminal 110.

When the mobility device M including the lower charging connector 100C is charged, the second terminal 120 may move upward and come into contact with the first terminal 110. Thus, the unmanned external charger 20 and the charging unit 200 may be electrically connected, and charging may proceed. Meanwhile, in the rear charging connector 100A, since the first terminal 110 and the second terminal 120 are separated from each other, no current may flow to the second terminal 120. Since no current flows to the second terminal 120 in the front charging connector 100B, it is possible to prevent water or foreign substances from flowing into the charging connector 100 located at the lower portion of the mobility device M, which may cause an accident.

According to embodiments, while charging is in progress through one of a plurality of charging ports, a charging connector located in another charging port is formed to be disconnected from the charging unit of the mobility device, thereby having an advantage of preventing occurrence of accidents.

According to embodiments, since the first terminal and the second terminal connected to the charging unit of the mobility device are physically separated from each other and the first terminal and the second terminal are configured to come into contact with each other by a force of inserting the external charger, there is an advantage of having convenience of charging and preventing the occurrence of accidents.

Although the present disclosure has been described above with reference to some embodiments thereof, it should be understood by those having ordinary skill in the art that various modifications and changes may be made to the present disclosure without departing from the spirit and scope of the present disclosure as set forth in the claims below.

What is claimed is:

1. A charging apparatus for a mobility device, the charging apparatus comprising:
a plurality of charging connectors to which an external charger is connected and which are located at different positions on the mobility device; and
a charging unit disposed inside of the mobility device and connected to the plurality of charging connectors,
wherein each of the plurality of charging connectors includes:
a first terminal connected to the charging unit, and
a second terminal that is electrically separated from the first terminal and configured to contact a connector of the external charger.

2. The charging apparatus for a mobility device of claim 1, wherein the second terminal is fixed to a housing of the charging connector, and the first terminal is formed to be elastically deformable.

3. The charging apparatus for a mobility device of claim 2, wherein the first terminal is located around the second terminal.

4. The charging apparatus for a mobility device of claim 2, wherein the first terminal includes a first electrode connected to the charging unit, a second electrode bent from the first electrode to be away from the first electrode, and a third electrode bent from the second electrode to be close to the first electrode.

5. The charging apparatus for a mobility device of claim 4, wherein, in case that the first electrode or the second electrode is deformed by coming into contact with the external charger, the second electrode or the first electrode is in contact with the second terminal, and the external charger and the charging unit are electrically connected.

6. The charging apparatus for a mobility device of claim 1, wherein the charging connector includes a front charging connector located at a front of the mobility device and a rear charging connector located at a rear of the mobility device.

7. The charging apparatus for a mobility device of claim 1, wherein the first terminal is fixed to a housing of the charging connector, and the second terminal is formed to be slidable on the charging connector.

8. The charging apparatus for a mobility device of claim 7, wherein the second terminal is connected to the charging connector to be slidable in a vertical direction.

9. The charging apparatus for a mobility device of claim 8, wherein the second terminal is moved toward the first terminal by the external charger while being lifted upward and comes into contact with the first terminal so that the external charger and the charging unit are electrically connected.

10. The charging apparatus for a mobility device of claim 9, wherein the first terminal and the second terminal are located on a bottom of the mobility device.

11. A mobility device including a charging apparatus connected to an external charger, wherein the charging apparatus includes:
a plurality of charging connectors to which an external charger is connected and which are located at different positions on the mobility device; and
a charging unit disposed inside of the mobility device and connected to the plurality of charging connectors,
wherein each of the plurality of charging connectors includes:
a first terminal connected to the charging unit, and
a second terminal that is electrically separated from the first terminal and configured to contact a connecter of the external charger.

12. The mobility device of claim 11, wherein some of the plurality of charging connectors are disposed at a front of the mobility device, and
others of the plurality of charging connectors are disposed at a rear of the mobility device.

13. The mobility device of claim 11, wherein some of the plurality of charging connectors are disposed at a bottom of the mobility device.

14. The mobility device of claim 11, wherein each of the plurality of charging connectors includes: a front charging connector located at a front of the mobility device, and a rear charging connector located at a rear of the mobility device.

15. The mobility device of claim 11, wherein the first terminal is tucked in by the external charger and comes into contact with the second terminal so that the external charger and the charging unit are electrically connected.

16. The mobility device of claim 11, wherein the second terminal is fixed to a housing of the charging connector, and the first terminal is formed to be elastically deformable.

17. The mobility device of claim 11, wherein the first terminal is located around the second terminal.

18. The mobility device of claim 11, wherein the first terminal includes a first electrode connected to the charging unit, a second electrode bent from the first electrode to be away from the first electrode, and a third electrode bent from the second electrode to be close to the first electrode.

19. The mobility device of claim 18, wherein, in case that the first electrode or the second electrode is deformed by coming into contact with the external charger, the second electrode or the first electrode is in contact with the second terminal, and the external charger and the charging unit are electrically connected.

20. The charging apparatus for a mobility device of claim 1, wherein the first terminal is tucked in by the external charger and comes into contact with the second terminal so that the external charger and the charging unit are electrically connected.
